(19) United States
(12) Patent Application Publication
(10) Pub. No.: US 2005/0003816 A1
(43) Pub. Date: Jan. 6, 2005

(54) Communications operating system and method therefor

(76) Inventors: George Vardoulias, Athens (GR); Nigel Drew, Wiltshire (GB); Jafar Daroughi-Esfahani, Bedfordshire (GB)

Correspondence Address: MOTOROLA, INC., 1303 EAST ALGONQUIN ROAD, IL01/3RD, SCHAUMBURG, IL, 60196, US

(21) Appl. No.: 10/472,842

(22) PCT Filed: Mar. 11, 2002
(86) PCT No.: PCT/EP02/02767

(30) Foreign Application Priority Data
Mar. 19, 2001 (GB) 0106692.7

(51) Int. Cl. H04B 7/00; H04Q 7/20

(52) U.S. Cl. 455/435.2; 455/525

(57) ABSTRACT

A mobile subscriber unit is provided with a memory (8) containing the cell selection and re-selection functions relating to a plurality of different radio networks (4 to 6) eg. GSM, UMTS, satelite, available in its locality, thus enabling the subscriber unit to identify and camp on to any one of the networks. Once a communications link is established, the subscriber unit requests over-the-air download of the full operating protocol from the chosen network. A self-check procedure is optionally provided to ensure that the downloaded data is fuctioning correctly. The choice of network may be influenced by user preference data held in a memory (10). The invention enables operation of a subscriber unit on a choice of many networks without the need for a large memory for holding the full protocols for all available networks.

### FIELD OF THE INVENTION

The present invention relates, in general, to communication systems and more particularly, to user equipments and their methods of operation.

### DISCUSSION OF THE BACKGROUND

Within the past several years, radio frequency (RF) communication systems have progressed from a very limited number of systems, each available for one type of function, to a vast number of potential systems available for providing the same type of basic service. For example, cellular communication systems began in Europe with the Nordic mobile telephone (NMT) system. At the time, this was the only system which provided mobile dial-up telephone operations. Since its introduction, newer analogue systems have been introduced, such as total access communication system (TACS), and more recently, digital systems such as group special mobile (GSM) and the third generation system (3G) often referred to as UMTS (Universal Mobile Telecommunications System) and currently under standardisation.

All these systems have several features which distinguish themselves from each other. For example, GSM and UMTS not only operate on different carrier frequencies but also use different multiple access systems. GSM uses a time division multiple access system and UMTS uses a code division multiple access system.

Conversely, there are features common to both systems, with both GSM and UMTS being cellular systems whereby a cell is supported by a single base station (in GSM terminology), or node B (in UMTS terminology). Several base stations or node B's are normally controlled by a base station controller or radio network controller, respectively.

The multiple access technologies referred to above permit multiple subscribers to each of these systems to access a serving base station simultaneously by means of a portable subscriber unit often referred to as a mobile station or a user equipment.

Until recently, one problem for the end user was that to be able to go anywhere in the world and use a subscriber unit, the user needed to carry different types of subscriber unit, since one unit alone would not operate on all of the systems. However, multi-mode and re-configurable user equipments are now becoming commercially available, allowing the user to select any one of several available communication systems, eg GSM or UMTS.

Ideally, a re-configurable user equipment should work on a wide range of systems and standards and particularly, should be able to detect and identity alternative communications networks available in its locality.

GB-A-2294844 discloses a method for enabling a user equipment to access one of many different networks, by initially accessing a common radio system which is in communication with each of the different networks. The common radio system provides to the user equipment, a list of networks available. The user equipment chooses one of the networks on the list and requests an enabling program from the common radio system so that communications between the user equipment and the chosen network may be set up directly. A limitation of this known method is that it does not allow direct access of one of a plurality of networks by a user equipment, ie. it requires the provision of a common radio system.

### SUMMARY OF THE INVENTION

According to a first aspect of the present invention, there is provided a user equipment for enabling a user to access one of a plurality of radio communications networks, the user equipment including;
a detector for detecting at least one of the plurality of radio communications networks,
a first store for storing network identification data and operational variables relevant to each of said plurality of networks,
a second store for storing data relevant to user preferences, an identifier for identifying detected networks by comparision of received signal characteristics with identification data stored in the first store,
a first selector for choosing one of the detected and identified networks by comparison with the data stored in the second store,
a second selector, for selecting operational variables stored in the first store and pertaining to the chosen network,
means for setting up a communications channel with the chosen network using the selected operational variables,
and means for receiving an enabling program thereby to enable communications with the chosen network.

According to a second aspect of the present invention there is provided a method of enabling a user equipment to access one of a plurality of radio communications networks, the method including the steps of;
detecting at least one of said networks,
identifying the detected networks,
choosing one of the detected and identified networks by comparison with stored user data,
selecting of operational variables pertaining to the chosen network from a network variable settings store,
setting up a communications channel with the chosen network using the selected operational variables,
and receiving an enabling program thereby enabling communications between the user equipment and the chosen network.

The enabling program may be requested from the chosen network by the user equipment and subsequently received over the communications channel and downloaded and stored into a dedicated store in the user equipment.

Alternatively, the enabling program may be downloaded into the user equipment by means of an appropriate plug-in card, or module, which is connected to the user equipment by the user once the network selection has been made and notified to the user (by means of a visual display, for example).

The network identification data may relate to characteristics of the signals received by the detector from the various networks, and may comprise, for example, carrier frequency, multiple access type, pilot signal frequency.

The user preferences in the second store may be set, for example, so that a detected UMTS network is always selected in preference to a GSM network. Alternatively, the stored preferences may include a preferred received signal strength, available data rate or quality of service, in which case the first selector chooses a detected and identified network which meets the preferred performance criteria. In this latter example, the identifier is adapted to determine such criteria from the detected signals from each network. The user preferences may be entered into the user equipment by the user with the aid of a key pad. Alternatively, a stored default list of preferences could be used or the user could select options from a pre-stored list.

The operational variables stored in the first store are sufficient to enable the user equipment to set up the communications channel with the selected network and preferably comprise the so-called “cell selection and re-selection functions” of each of the plurality of networks. Once the channel has been established, the enabling program, ie., the full protocol for registering with and enabling communications with a chosen network, may be downloaded over the communications channel and stored in the user equipment.

Optionally, the user equipment may also perform a self-check for checking that the enabling program has been downloaded successfully and that the user equipment has been re-configured correctly as a result of the download.

Advantageously, the invention enables the user equipment to identify and set up a communications link with an available network directly, without going through any common system, and also enables the user equipment to monitor other available networks whilst registered with the chosen network.

The invention has the further advantage in that no extra pilot channel is required by each network for imparting network data to a user equipment.

Further, the user equipment is not required to permanently store the full enabling program for every available network. Such a requirement would necessitate very large amounts of memory.

The enabling program which is downloaded is a reduced protocol rather than a full protocol, therefore, download time is minimised and spectral efficiency is maximised.

### BRIEF DESCRIPTION OF THE DRAWINGS

Some embodiments of the invention will now be described, by way of example only, with reference to the drawings of which;

FIG. 1 is a block diagram of a user equipment in accordance with the invention,

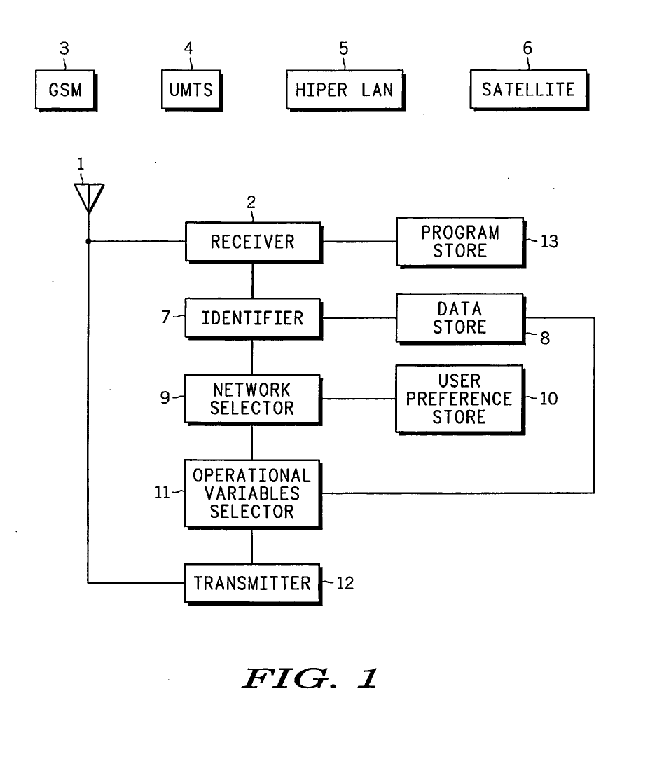

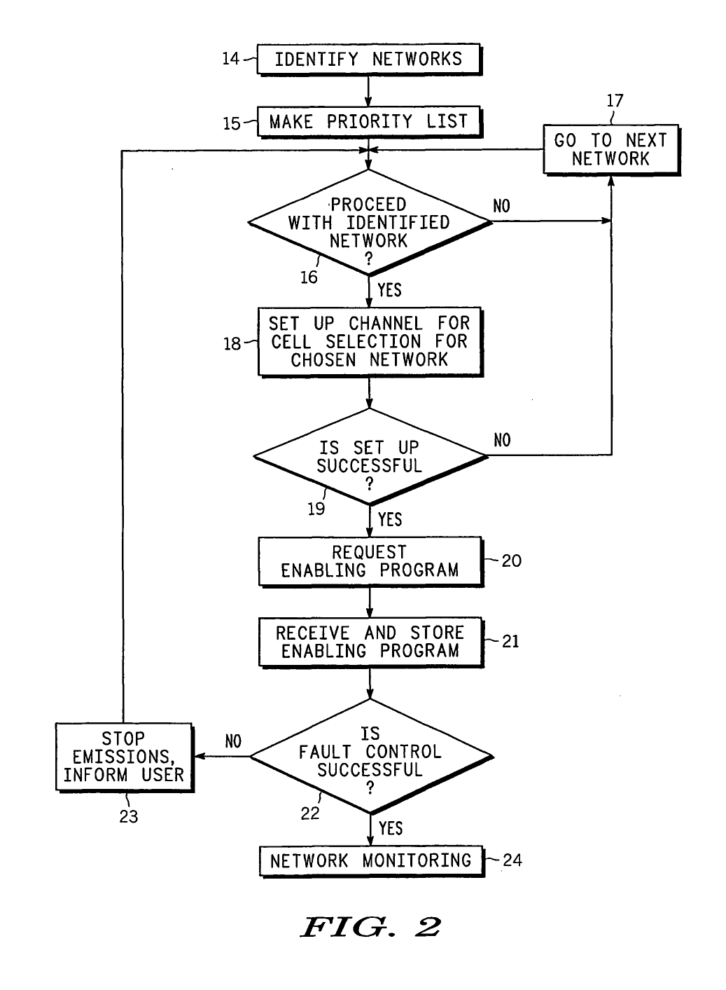

and FIG. 2 is a flow chart showing operation of the user equipment of FIG. 1.

### DETAILED DESCRIPTION OF THE PREFERRED EMBODIMENTS

In FIG. 1, a user equipment includes an antenna 1 and receiver 2 which are capable of detecting transmissions from a plurality of different communications networks 3 to 6. In this example four different networks are represented, these being GSM, UMTS, HiperLAN and a satellite system. Each of the four different communications systems, 3 to 6 operate on different RF carrier frequencies and have different multiple-access types of operation and other operating protocols. Hence, each network has distinguishing and identifiable characteristics.

Each detected system is subsequently identified by an identifier module 7, connected to an output of the receiver 2, by comparison with data held in a store 8.

Store 8 holds the cell selection and re-selection functions for each network 3 to 6 and includes network identification data, operational variable settings for each network and a fault control procedure.

An output of the identifier 7, which comprises a list of the detected networks, is connected to a network selection module 9.

The function of the network selection module 9 is to choose one of the detected networks 3 to 6 by comparison with the data held in a user preference store 10.

The user preference store 10 holds data relevant to the preferences of the user eg. network type, quality of service, available data rate, tariffs.

The choice of network which is made by the network selector 9, is communicated to an operational variables selector module 11.

The selector module 11 interrogates the data store 8 for the operational variable settings pertaining to the chosen network. The selector module 11 then provides these settings to a transmitter 12 which, in turn, sets up a communications channel (to allow the cell selection), with the chosen network via the antenna 1 and using the settings provided.

The transmitter 12 is also configured to transmit a request over the communications channel, to the chosen network, for an enabling program, to allow the user equipment to access all communications services supplied by the chosen network.

The enabling program, subsequently sent by the chosen network is received by the receiver 2 and stored in a program store 13 for subsequent use by the user equipment. The enabling program comprises the full protocol required for communications with the chosen network, whereas the data store 8 holds only a reduced protocol.

Operation of the user equipment of FIG. 1 will now be described with reference to the flow chart of FIG. 2.

At step 14, the available networks are identified.

At step 15, a check is made to determine if any of the identified networks are excluded by the user preferences and a priority list for the networks is made according to the user preference data.

At step 16, the identified network which is first on the priority list is displayed to the user who either accepts or rejects it by making an appropriate entry using the user equipment's key pad. If the user rejects it, then the next network on the priority list is presented (step 17) and so on.

Once the user has accepted a network, the user equipment attempts to set up a communications channel for cell selection with the chosen network at step 18. If the attempt is unsuccessful, steps 17 and 16 are repeated. If the attempt is successful (step 19), then a request is sent over the channel for an enabling program comprising the full protocol necessary for full communications with the chosen network (step 20).

At step 21, the protocol is received and stored for subsequent use.

At step 22, a fault control, ie. self check procedure is carried out. This check is configured to ensure that the user equipment, now containing the downloaded full protocol, complies with air interface emission regulations. This self check is performed by means of the fault procedure held in the store 8.

In this example, the user equipment receives a command from the chosen network, for example, to set power output at a specific level. The fault procedure instigates a check, at step 22, that the stored full protocol has, in fact, set the power level at the correct value commanded by the network. If the level has not been set correctly, the user equipment shuts down its transmissions and informs the user (step 23) by way of a visual display. Otherwise, the user equipment can proceed with communications with the chosen network and at the same time, monitor the other available networks (step 24).

1. A user equipment for enabling a user to access one of a plurality of radio communications networks (3-6), the user equipment including;
a detector (1) for detecting at least one of the plurality of radio communications networks (3-6),
a first store (8) for storing network identification data and operational variables relevant to each of said plurality of networks,
a second store (10) for storing data relevant to user preferences,
an identifier (7) for identifying detected networks by comparison of received signal characteristics with identification data stored in the first store (8),
a first selector (9) for choosing one of the detected and identified networks by comparison with the data stored in the second store (10),
a second selector (11) for selecting operational variables stored in the first store (8) and pertaining to the chosen network,
means (12) for setting up a communications channel with the chosen network using the selected operational variables,
and means for receiving (2) an enabling program, thereby to enable communications with the chosen network.

2. A user equipment according to claim 1 and further including means (12) for requesting the enabling program from the chosen network.

3. A user equipment according to claim 2 and further including a third store (13) for storing the enabling program.

4. A user equipment according to claim 1 and further including a module (13) containing the enabling program.

5. A user equipment according to claim 1 in which the first store (8) includes cell selection and re-selection functions for each of the plurality of radio communications networks (3-6).

6. A user equipment according to claim 1 and further including means (8) for performing a self-check procedure.

7. A method of enabling a user equipment to access one of a plurality of radio communications networks, the method including the steps of;
detecting at least one of said networks,
identifying (14) the detected networks,
choosing (15,16) one of the detected and identified networks by comparison with stored user data,
selecting operational variables pertaining to the chosen network from a network variable settings store,
setting up (18) a communications channel with the chosen network using the selected operational variables,
and receiving (21) an enabling program, thereby enabling communication between the user equipment and the chosen network.

8. A method according to claim 7 and including the further steps of requesting (20) the enabling program from the chosen network and storing (21) said enabling program within said user equipment.

9. A method according to claim 7 in which the stored user data relates to network performance capabilities.

10. A method according to claim 7 and including the further step of performing a self check procedure (22).
